(19) United States
(12) Patent Application Publication
(10) Pub. No.: US 2019/0389089 A1
(43) Pub. Date: Dec. 26, 2019

(54) CERAMIC 3D PRINTER CAPABLE OF SCRAPING

(71) Applicant: DONGGUAN UNIVERSITY OF TECHNOLOGY, DONGGUAN (CN)

(72) Inventor: CHUAN LI, DONGGUAN (CN)

(21) Appl. No.: 16/416,935

(22) Filed: May 20, 2019

(30) Foreign Application Priority Data
Jun. 20, 2018 (CN) CN2018106334822

(51) Int. Cl. B28B 1/00; B33Y 30/00

(52) U.S. Cl. CPC B28B 1/001; B33Y 30/00

(57) ABSTRACT

The present invention relates to a ceramic 3D printer capable of scraping, which comprises a frame provided with a mounting plate; the mounting plate is fixedly embedded with a forming drum, the lower part of the forming drum is a light transmissive block, and at the bottom of the frame is provided with a spot emitting device cooperating with the light transmissive block, the mounting plate is further provided with a forming lifting rack, the forming lifting rack is provided with a lifting cylinder that can be inserted into the forming drum, a forming lifting block is arranged under the lifting cylinder, and to the outside of the forming drum is provided with a scraping device, and the location of the scraping device is higher than the height of the inner liquid surface in the forming drum, the scraping device comprises a scraping cylinder disposed horizontally outside the forming drum, the scraping cylinder is connected with a movable scraping block, and the movable scraping block is connected with a scraping block that can be inserted into the forming drum. In the present invention, the part of the side of the forming drum that exceeds the liquid surface thereof is provided with a scraping device that can be inserted therein. The scraping block scrapes the printed part under the forming lifting block to ensure that the printed part is flat, thereby ensuring the performance of the printed part joints.

### FIELD OF THE INVENTION

The present invention relates generally to the field of the 3D printing, and more particularly to a ceramic 3D printer capable of scraping.

### BACKGROUND OF THE INVENTION

With the development and advancements in technology, 3D printing devices are becoming more and more popular, among which the ceramic 3D printers can produce smoother products by light spot solidification and forming, and are widely used. Most of the existing ceramic 3D printers have forming drums, the bottom thereof comprises a light transmissive block, thereunder are provided light spot emitters, and on their upper part are forming lifting blocks; the printed part is raised by the forming lifting block, and printing is conducted on the lower part; there are several defects with this printing method, such as: there may be burrs happening when the late printed part is joined with the upper part, which results in the not sufficiently good performance at the joint, affecting the quality of the printed product.

### OVERALL OBJECTIVE OF THE INVENTION

The overall objective of the present invention is to provide a ceramic 3D printer capable of scraping, the part to the side of the forming drum that is higher than level of the liquid surface is provided with a scraping device that can be inserted into the forming drum. By scraping the printed part under the forming lifting block with the scraping block, it is possible to promise a flat printed part, and joint of printed parts can be of good performance, improving 3D printing effects.

### SUMMARY OF THE INVENTION

In order to achieve the above objective, the technical solutions adopted by the present invention are: a ceramic 3D printer capable of scraping comprises a frame, the frame is provided with a mounting plate, the mounting plate is fixedly embedded with a forming drum, the lower part of the forming drum is a light transmissive block, the bottom of the frame is provided with a spot emitting device cooperating with the light transmissive block, the mounting plate is further provided with a forming lifting rack, the forming lifting rack is provided with a lifting cylinder that can be inserted into the forming drum, a forming lifting block is arranged under the lifting cylinder, wherein the outside of the forming drum is provided with a scraping device, and the location of the scraping device is higher than the height of the inner liquid surface in the forming drum, the scraping device comprises a scraping cylinder disposed horizontally outside the forming drum, the scraping cylinder is connected with a movable scraping block, and the movable scraping block is connected with a scraping block that can be inserted into the forming drum. Further, the upper part of the scraping block is embedded with a scraping and grinding block flush with the upper surface thereof, and the length of the scraping block is greater than half of the maximum spacing between the inner walls of the forming drum, the lower part of the scraping block is provided with a scraping movable limit block, the forming lifting rack is provided with a rotary lifting motor, and the lifting cylinder is mounted on the output shaft of the rotary lifting motor.

Further, the underside of the scraping block is provided with a grinding block locking opening, a grinding block mounting screw that can be inserted into the grinding block locking opening is fixed under the scraping block and is locked by a grinding block locking nut.

Further, a feeding box is disposed outside the forming drum, and the forming drum is provided with a feeding port cooperating with the feeding box, the height of the feeding port is not lower than the height of the liquid level required by 3D printing, the middle of the feeding box is provided with a feeding partition plate to divide it into two cavities whose lower parts are in communication with each other, the outer cavity is provided with a feeding press plate sealingly fitting the cavity wall thereof, a feeding press bar is disposed above the feeding press plate.

Further, the forming lifting block are provided with a vertical oriented forming discharge holes, the upper part of the forming discharge holes is provided with a discharge hole sealing plate sealingly fitting the forming discharge holes, the discharge hole sealing plate is mounted on the forming lifting block by sealing plate locking bolts.

Further, the outside of the discharge hole sealing plate is provided with a material forming holding cone which is small on the upper part and big on the lower side, and the height of the material forming holding cone is greater than the distance between the feeding port and the light transmissive block, and the outside of the material forming holding cone is provided with mixing rods.

Further, the inner end of the lowermost mixing rods are connected with material holding cone positioning rods, and the material holding cone positioning rods penetrates into the discharge hole sealing plate by thread connection, and at the lower part of the material forming holding cone are provided the material holding cone positioning rods cooperating with the forming lifting block by plugging and fitting.

The beneficial effects of the present invention are:

The part of the side of the forming drum that exceeds the liquid surface is provided with a scraping device that can be inserted therein. The scraping block scrapes the printed part under the forming lifting block to ensure that the printed part is flat, thereby ensuring the performance of the printed joint portion, improving the effect of ceramic 3D printing.

By the cooperation of the scraping and grinding block and the feeding rotary motor it is possible to smooth the lower part of the formed part by rotating and grinding, further ensuring the effect of the scraping.

The structure of the grinding block mounting screw and the grinding block locking opening will not affect the overall structure of the scraping block, but also facilitate the mounting and dismounting of the scraping block.

The structure of the feeding device and the feeding port facilitates the feeding of the forming drum, and avoiding interference with the scraping part during feeding; design of the feeding port can avoid contact between the material in the forming drum and the scraping device.

The structure of the forming discharge holes and the discharge hole sealing plate can not only facilitate the discharging of the product after forming, but also avoid the material forming in the upper part of the forming lifting block.

The structure of the material forming holding cone can avoid the material entering the upper part of the forming lifting block during the forming process, and the externally arranged mixing rods can also cooperate with the feeding rotary rotor to realize the stirring of the material.

The structure of the material holding cone locking screw facilitates the discharging of the material forming holding cone and the discharge hole sealing plate, thereby facilitating the discharging of materials, and design of the material holding cone positioning rod can achieve a good positioning effect.

### BRIEF DESCRIPTION OF THE DRAWINGS

FIG. 1 is the schematic structure view of a ceramic 3D printer capable of scraping;

FIG. 2 is the schematic structure view of the scraping device;

FIG. 3 is the partial enlarged view of A in FIG. 2;

FIG. 4 is the schematic structure view of a part of a forming lifting block;

FIG. 5 is a partial enlarged view of B in FIG. 4; and

FIG. 6 is the schematic structure view of the feeding device.

### REFERENCE NUMBER KEY

The drawings comprises following integers:
1—Frame;
2—Mounting plate;
3—Forming drum;
4—Light transmissive block;
5—Spot emitting device;
6—Forming lifting rack;
7—Rotary lifting motor;
8—Lifting cylinder;
9—Forming lifting block;
10—Scraping device;
11—Feeding device;
12—Scraping cylinder;
13—Movable scraping block;
14—Scraping block;
15—Scraping movable limit block;
16—Scraping and grinding block;
17—Grinding block mounting screw;
18—Grinding block locking nut;
19—Grinding block locking opening;
21—Forming discharge hole;
22—Discharge hole sealing plate;
23—Sealing plate locking nut;
24—Material forming holding cone;
25—Mixing bar;
26—Material holding cone locking screw;
27—Material holding cone positioning rod;
31—Feeding port;
32—Feeding box;
33—Feeding partition plate;
34—Feeding press plate;
35—Feeding press rod.

### DETAILED DESCRIPTION OF THE ILLUSTRATED EMBODIMENT

The present invention will be described in detail below with reference to the accompanying drawings, the description of the present invention is only exemplary and explanatory, and should not be construed as limit the scope of the present invention.

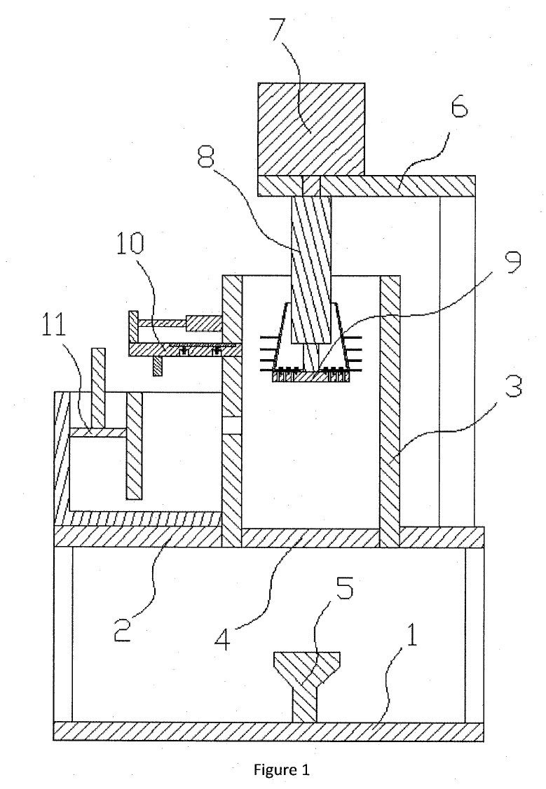

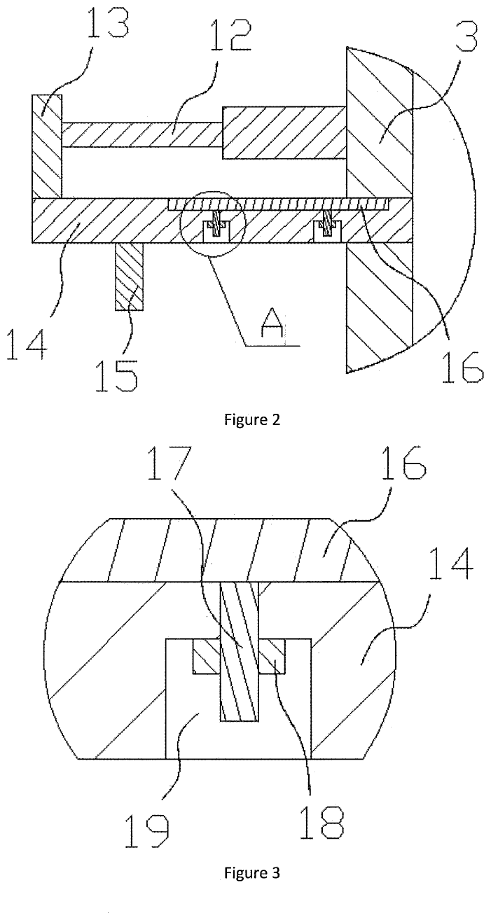

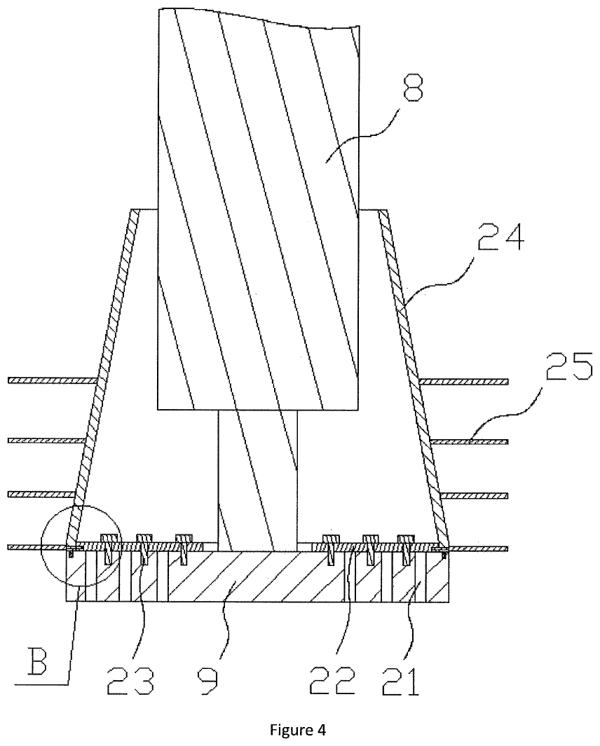

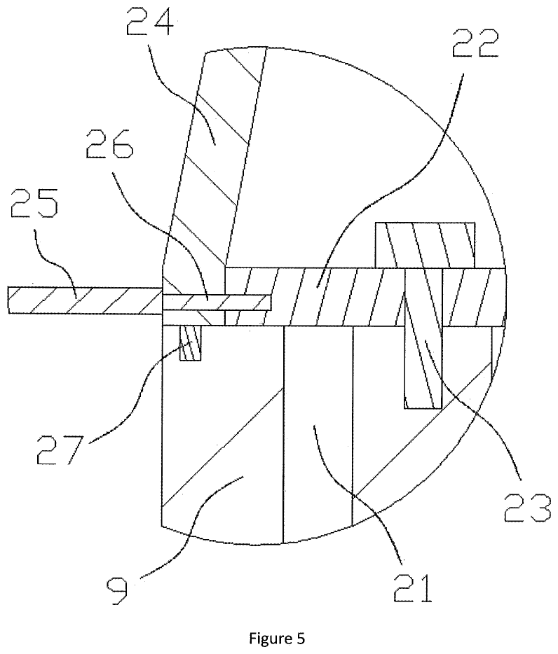

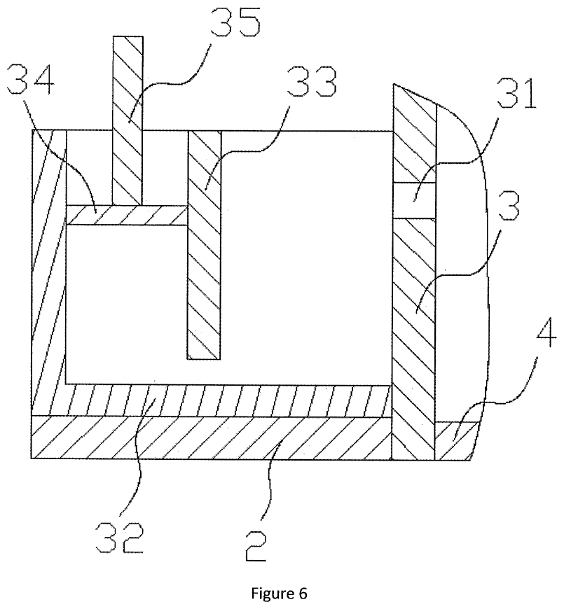

As shown in FIGS. 1 to 6, the specific structure of the present invention is: A ceramic 3D printer capable of scraping comprises a frame 1, the frame 1 is provided with a mounting plate 2, the mounting plate 2 is fixedly embedded with a forming drum 3, the lower part of the forming drum 3 is a light transmissive block 4, the bottom of the frame 1 is provided with a spot emitting device 5 cooperating with the light transmissive block 4, the mounting plate 2 is further provided with a forming lifting rack 6, the forming lifting rack 6 is provided with a lifting cylinder 8 that can be inserted into the forming drum 3, a forming lifting block 9 is arranged under the lifting cylinder 8, wherein the outside of the forming drum 3 is provided with a scraping device 10, and the location of the scraping device 10 is higher than the height of the inner liquid surface in the forming drum 3, the scraping device 10 comprises a scraping cylinder 12 disposed horizontally outside the forming drum 3, the scraping cylinder 12 is connected with a movable scraping block 13, and the movable scraping block 13 is connected with a scraping block 14 that can be inserted into the forming drum 3.

Preferably, the upper part of the scraping block 14 is embedded with a scraping and grinding block 16 flush with the upper surface thereof, and the length of the scraping block 16 is greater than half of the maximum spacing between the inner walls of the forming drum 3, the lower part of the scraping block 14 is provided with a scraping movable limit block 15, the forming lifting rack 6 is provided with a rotary lifting motor 7, and the lifting cylinder 8 is mounted on the output shaft of the rotary lifting motor 7. Preferably, the underside of the scraping block 14 is provided with a grinding block locking opening 19, a grinding block mounting screw 17 that can be inserted into the grinding block locking opening 19 is fixed under the scraping block 16 and is locked by a grinding block locking nut 18.

Preferably, a feeding box 32 is disposed outside the forming drum 3, and the forming drum 3 is provided with a feeding port 31 cooperating with the feeding box 32, the height of the feeding port 31 is not lower than the height of the liquid level required by 3D printing, the middle of the feeding box 32 is provided with a feeding partition plate 33 to divide it into two cavities whose lower parts are in communication with each other, the outer cavity is provided with a feeding press plate 34 sealingly fitting the cavity wall thereof, a feeding press bar 35 is disposed above the feeding press plate 34.

Preferably, the forming lifting block 9 are provided with a vertical oriented forming discharge holes 21, the upper part of the forming discharge holes 21 is provided with a discharge hole sealing plate 22 sealingly fitting the forming discharge holes 21, the discharge hole sealing plate 22 is mounted on the forming lifting block 9 by sealing plate locking bolts 23.

Preferably, the outside of the discharge hole sealing plate 22 is provided with a material forming holding cone 24 which is small on the upper part and big on the lower side, and the height of the material forming holding cone 24 is greater than the distance between the feeding port 31 and the light transmissive block 4, and the outside of the material forming holding cone 24 is provided with mixing rods 25.

Preferably, the inner end of the lowermost mixing rods 25 are connected with material holding cone positioning rods 27, and the material holding cone positioning rods 27 penetrates into the discharge hole sealing plate 22 by thread connection, and at the lower part of the material forming holding cone 24 are provided the material holding cone positioning rods 27 cooperating with the forming lifting block 9 by plugging and fitting. When in use, debug the device, and place the printing material in the feeding box 32. The feeding press bar 35 presses the feeding partition plate 34, and further presses the printing material from the feeding port 31 into the forming drum 3, the lifting cylinder 8 drives the forming lifting block 9 to descend into the material, and during the descending process, the feeding rotary motor 7 drives the forming lifting block 9 to rotate, thereby the mixing rods 25 are driven to rotate, the material is mixed evenly, and the forming lifting block 9 and the light transmissive block 4 stop descending and rotating when they are forming a proper height difference. The spot emitting device 5 emits a suitable light beam to cause the material irradiated by the light beam to solidify under the forming lifting block 9, thereby completing a part of the ceramic 3D printing. After that, the lifting cylinder 8 drives the forming lifting block 9 to rise, thereby the part formed under the forming lifting block 9 exceeds the height of the scraping device and drive the scraping block 14 into the forming drum 3 with the scraping cylinder 12 until the scraping movable limit block 15 is pressed against the outer wall of the forming drum 3.

At this time, the outer end of the scraping block is flush with the inner wall of the forming drum 3, and then the forming lifting block 9 is lowered by the lifting cylinder 8. So the lower part of the forming part is in contact with the scraping block, and then the rotary lifting motor 7 drives the forming lifting block 9 to rotate, thereby drives the printed part to rotate and completing the smoothing of the lower side of the printed part. After that, the scraping device is returned to the original position, and then the feeding, forming and scraping operations are repeated until the product has completed forming. Then rotate the lowermost mixing rods 25 to drive the material holding cone locking screw 26 away from the discharge hole sealing plate 22 and the material forming holding cone 24. Extract the material forming holding cone 24 upward, loosen the sealing plate locking bolt 23, and remove the discharge hole sealing plate 22 and by inserting the material discharging pins into the forming discharge holes 21 free the formed product. In this way, the whole process of ceramic 3D printing is completed.

It is to be understood that the term “comprises”, “comprising” or any other variations thereof is intended to encompass a non-exclusive inclusion, such that a process, method, article, or device that comprises a series of elements also comprises other elements that are not explicitly listed, or elements that are inherent to such a process, method, item, or device.

The principles and embodiments of the present invention have been described herein with reference to specific examples. The description of the above examples is only to aid in understanding the method of the present invention and its core idea. The above description is only a preferred embodiment of the present invention, and it should be noted that due to the finiteness of the textual expression, there is an infinitely specific structure objectively, those skilled in the art can also make a number of modifications, refinements or variations without departing from the principles of the present invention, and the above technical features may be combined in an appropriate manner; these modifications, variations, or combinations, or the concept and technical solution of the invention are directly applied to other occasions without any modifications, all should be regarded as the protection scope of the present invention.

What is claimed is:

1. A ceramic 3D printer capable of scraping comprises a frame (1), the frame (1) is provided with a mounting plate (2), the mounting plate (2) is fixedly embedded with a forming drum (3), the lower part of the forming drum (3) is a light transmissive block (4), the bottom of the frame (1) is provided with a spot emitting device (5) cooperating with the light transmissive block (4), the mounting plate (2) is further provided with a forming lifting rack (6), the forming lifting rack (6) is provided with a lifting cylinder (8) that can be inserted into the forming drum (3), a forming lifting block (9) is arranged under the lifting cylinder (8), wherein the outside of the forming drum (3) is provided with a scraping device (10), and the location of the scraping device (10) is higher than the height of the inner liquid surface in the forming drum (3), the scraping device (10) comprises a scraping cylinder (12) disposed horizontally outside the forming drum (3), the scraping cylinder (12) is connected with a movable scraping block (13), and the movable scraping block (13) is connected with a scraping block (14) that can be inserted into the forming drum (3).

2. The ceramic 3D printer capable of scraping of claim 1, wherein the upper part of the scraping block (14) is embedded with a scraping and grinding block (16) flush with the upper surface thereof, and the length of the scraping block (16) is greater than half of the maximum spacing between the inner walls of the forming drum (3), the lower part of the scraping block (14) is provided with a scraping movable limit block (15), the forming lifting rack (6) is provided with a rotary lifting motor (7), and the lifting cylinder (8) is mounted on the output shaft of the rotary lifting motor (7).

3. The ceramic 3D printer capable of scraping of claim 2, wherein the underside of the scraping block (14) is provided with a grinding block locking opening (19), a grinding block mounting screw (17) that can be inserted into the grinding block locking opening (19) is fixed under the scraping block (16) and is locked by a grinding block locking nut (18).

4. The ceramic 3D printer capable of scraping of claim 2, wherein a feeding box (32) is disposed outside the forming drum (3), and the forming drum (3) is provided with a feeding port (31) cooperating with the feeding box (32), the height of the feeding port (31) is not lower than the height of the liquid level required by 3D printing, the middle of the feeding box (32) is provided with a feeding partition plate (33) to divide it into two cavities whose lower parts are in communication with each other, the outer cavity is provided with a feeding press plate (34) sealingly fitting the cavity wall thereof, a feeding press bar (35) is disposed above the feeding press plate (34).

5. The ceramic 3D printer capable of scraping of claim 4, wherein the forming lifting block (9) are provided with a vertical oriented forming discharge holes (21), the upper part of the forming discharge holes (21) is provided with a discharge hole sealing plate (22) sealingly fitting the forming discharge holes (21), the discharge hole sealing plate (22) is mounted on the forming lifting block (9) by sealing plate locking bolts (23).

6. The ceramic 3D printer capable of scraping of claim 5, wherein the outside of the discharge hole sealing plate (22) is provided with a material forming holding cone (24) which is small on the upper part and big on the lower side, and the height of the material forming holding cone (24) is greater than the distance between the feeding port (31) and the light transmissive block (4), and the outside of the material forming holding cone (24) is provided with mixing rods (25).

7. The ceramic 3D printer capable of scraping of claim 6, wherein the inner end of the lowermost mixing rods (25) are connected with material holding cone positioning rods (27), and the material holding cone positioning rods (27) penetrates into the discharge hole sealing plate (22) by thread connection, and at the lower part of the material forming holding cone (24) are provided the material holding cone positioning rods (27) cooperating with the forming lifting block (9) by plugging and fitting.
